(19) United States
(12) Patent Application Publication
(10) Pub. No.: US 2014/0358487 A1
(43) Pub. Date: Dec. 4, 2014

(54) SYSTEM AND METHOD FOR ANALYZING SENSED DATA

(71) Applicant: SAMSUNG SDS CO., LTD., Seoul (KR)

(72) Inventor: Kae Young SHIN, Seoul (KR)

(73) Assignee: SAMSUNG SDS CO., LTD., Seoul (KR)

(21) Appl. No.: 14/012,395

(22) Filed: Aug. 28, 2013

(30) Foreign Application Priority Data
May 31, 2013 (KR) 10-2013-0062301

(51) Int. Cl. G06F 17/10

(52) U.S. Cl. CPC G06F 17/10
USPC 702/190

(57) ABSTRACT

A system and method for analyzing sensed data are disclosed. The system for analyzing sensed data according to an exemplary embodiment of the present disclosure includes a data extraction unit that extracts sensed data from a plurality of sensors arranged in a specific region or apparatus, a reference signal generation unit that generates a reference signal for each of the plurality of sensors from the sensed data, and a sensor detection unit that detects one or more sensors having a correlation with a state of the specific region or apparatus using the sensed data and the reference signal.

### CROSS-REFERENCE TO RELATED APPLICATION

This application claims priority to and the benefit of Republic of Korea Patent Application No. 10-2013-0062301, filed on May 31, 2013, the disclosure of which is incorporated herein by reference in its entirety.

### BACKGROUND

1. Field

Embodiments of the present disclosure relate to techniques for analyzing data output from sensors.

2. Discussion of Related Art

With the development of sensors and related technology, various sensors have been widely used in several fields. For example, a building management system (BMS) has temperature sensors, humidity sensors, pressure sensors or the like arranged in an entire building or a specific region in the building so that, based on values sensed by and received from the arranged sensors, a state of the building can be checked or necessary measures can be taken. Further, various types of sensors are arranged in a structure such as an elevator or a bridge, or an apparatus such as a car, a ship or a plane, thereby facilitating detection of anomalies in the structure or the apparatus and location of the anomalies based on their sensed values.

However, a related system for analyzing sensed data merely indicates whether or not there exist anomalies in the sensor-equipped region or apparatus based on comparison of the data output from the sensors to a predetermined criterion, and has limited capabilities in identifying a sensor having an effect on a state of such region or apparatus.

### SUMMARY

One or more exemplary embodiments may overcome the above disadvantage and/or other disadvantages not described above. However, it is understood that one or more exemplary embodiment are not required to overcome the disadvantage described above, and may not overcome any of the problems described above.

Embodiments of the present disclosure are directed to sensed data analysis of analyzing data output from sensors arranged in a specific region or device so that a sensor related to a state of the specific region or apparatus can be recognized with a degree of accuracy.

According to an exemplary embodiment, there is provided a system intended for use in analyzing sensed data, the system including a computer executing program commands and implementing: a data extraction unit configured to extract respective sensed data from each sensor of a plurality of sensors arranged in a specific region or apparatus; a reference signal generation unit configured to generate a reference signal for said each sensor, from the sensed data; and a sensor detection unit configured to detect one or more sensors of the plurality of sensors having a correlation with a state of the specific region or apparatus using the sensed data and the reference signal.

In an aspect of the system, the data extraction unit is further configured to carry out one of a correction operation and a filter operation with respect to the sensed data, based on a number of values missing from the sensed data.

In an aspect of the system, the data extraction unit is further configured to remove the sensed data, extracted from a specific sensor of the plurality of sensors, when the number of values missing from the respective extracted sensed data exceeds a predetermined threshold value.

In an aspect of the system, the data extraction unit is further configured to remove the sensed data related to a specific state when the number of values missing from the sensed data related to the specific state exceeds a predetermined threshold value.

In an aspect of the system, the sensor detection unit is further configured to calculate a distance between the respective sensed data and the reference signal, and detects one or more of the plurality of sensors having a correlation with the state of the specific region or apparatus based on the calculated distance.

In an aspect of the system, the system also includes a preprocessing unit configured to perform preprocessing with respect to the sensed data and the reference signal, including at least one of a compression operation, a normalization operation, and a symbolization operation.

In an aspect of the system, the preprocessing unit is further configured to compress the sensed data by: grouping the sensed data into a plurality of time intervals; and calculating a representative value of the sensed data in each of the grouping time intervals.

In an aspect of the system, the representative value is one of an average value and a median value of the sensed data, in each grouped time interval.

In an aspect of the system, the reference signal generation unit is further configured to: generate the reference signal by grouping the compressed sensed data from each sensor into one of a good group and a bad group, based on state information of one of the specific region and apparatus; and calculate one of an average value and a median value of the sensed data belonging to the good group, for each time interval.

In an aspect of the system, the reference signal generation unit is further configured to remove an outlier from the good group before generating the reference signal.

In an aspect of the system, at least one of a data start time and a data end time of the outlier is not included in a predetermined normal range.

In an aspect of the system, the normal range is calculated using at least one of an average value and a standard deviation of one of the data start time and the data end time of the sensed data included in the good group.

In an aspect of the system, the preprocessing unit is further configured to: normalize the compressed sensed data using an average and a variance of the reference signal; and convert a sensed value of the normalized sensed data and the reference signal to a plurality of symbols according to a predetermined sensed value range.

In an aspect of the system, the sensor detection unit is further configured to generate a decision tree by: generating a distance table using the symbolized sensed data and reference signal, and the state information of the specific region or apparatus; and applying a CART (Classification And Regression Tree) algorithm to the distance table.

In an aspect of the system, the sensor detection unit is further configured to detect, as a sensor having a correlation with the state of the specific region or apparatus, a sensor for which a Gini index, derived from the application of the CART algorithm, is at least a predetermined value.

According to another exemplary embodiment, there is provided a method, intended for use in analyzing sensed data, the method including: extracting, by a data extraction unit, sensed data from each sensor of a plurality of sensors included in a specific region or apparatus; generating, by a reference signal generation unit, a reference signal for said each sensor, from the sensed data; and detecting, by a sensor detection unit, one or more sensors of the plurality of sensors having a correlation with a state of the specific region or apparatus, using the sensed data and the reference signal.

In an aspect of the method, the extracting of the sensed data includes carrying out one of a correcting operation and a filtering operation with respect to the sensed data, based on a number of values missing from the sensed data.

In an aspect of the method, the method also includes removing the sensed data extracted, from a specific sensor of the plurality of sensors, when the number of values missing from the respective extracted sensed data exceeds a predetermined threshold value.

In an aspect of the method, the method also includes removing the sensed data related to a specific state when the number of values missing from the sensed data related to the specific state exceeds a predetermined threshold value.

In an aspect of the method, the detecting of the sensors includes calculating a distance between the respective sensed data and the reference signal, and detecting one or more of the plurality of sensors having a correlation with the state of the specific region or apparatus based on the calculated distance.

In an aspect of the method, the method also includes, after the extracting of the sensed data and before the generating of the reference signal, compressing the extracted sensed data using a preprocessing unit.

In an aspect of the method, the compressing of the sensed data includes: grouping the sensed data into a plurality of time intervals; and calculating a representative value of the sensed data in each grouping time interval.

In an aspect of the method, the representative value is one of an average value and a median value of the sensed data in each grouped time interval.

In an aspect of the method, the generating of the reference signal for each sensor includes: grouping the compressed sensed data from each sensor into one of a good group and a bad group based on state information of the specific region or apparatus; and calculating one of an average value and a median value of the sensed data belonging to the good group, for each time interval.

In an aspect of the method, the grouping of the compressed sensed data includes removing an outlier from the good group.

In an aspect of the method, at least one of a data start time and a data end time of the outlier is not included in a predetermined normal range.

In an aspect of the method, the normal range is calculated using at least one of an average value and a standard deviation of one of the data start time and the data end time of the sensed data included in the good group.

In an aspect of the method, the method also includes, before the detecting of the one or more sensors: normalizing, by the preprocessing unit, the compressed sensed data using an average and a variance of the reference signal; and converting, by the preprocessing unit, a sensed value of the normalized sensed data and the reference signal to a plurality of symbols according to a predetermined sensed value range.

In an aspect of the method, the detecting of the one or more sensors includes: generating a distance table using the symbolized sensed data and reference signal and the state information of the specific region or apparatus; and applying a CART (Classification And Regression Tree) algorithm to the distance table.

In an aspect of the method, the detecting of the one or more sensors further includes detecting, as a sensor having a correlation with the state of the specific region or apparatus, a sensor for which a Gini index derived from the application of the CART algorithm is at least a predetermined value.

According to yet another exemplary embodiment, there is provided a device including: one or more processors; a memory; and one or more programs stored in the memory, the one or more programs being configured to be executed by the one or more processors; wherein the one or more programs enable the one or more processors to carry out operations, comprising: extracting sensed data from each sensor of a plurality of sensors arranged in a specific region or apparatus; generating a reference signal for said each sensor from the sensed data; and detecting one or more sensors of the plurality of sensors having a correlation with a state of the specific region or apparatus, using the sensed data and the reference signal.

### BRIEF DESCRIPTION OF THE DRAWINGS

The above and other objects, features and advantages of the exemplary embodiments of the present disclosure will become more apparent to those skilled in the art from the following detailed description when taken in conjunction with the accompanying drawings, in which:

FIG. 1 is a block diagram for illustrating a sensed data analysis system 100 according to an exemplary embodiment of the present disclosure; and

FIG. 2 is a flowchart for illustrating a sensed data analysis method 200 according to an exemplary embodiment of the present disclosure.

### DETAILED DESCRIPTION OF EXEMPLARY EMBODIMENTS

Exemplary embodiments of the present disclosure will be described below with reference to the accompanying drawings. However, the exemplary embodiments are only illustrative and the present disclosure is not limited thereto.

In the following detailed description, various details known to those familiar with this field may be omitted to avoid obscuring the gist of the present disclosure. Also, terminology described below is defined with reference to functions in the present disclosure and may vary according to a user's or an operator's intention or usual practice. Therefore, the meanings of the terminology should be interpreted based on the overall context of the present specification.

The spirit of the present disclosure is determined by the claims, and the following exemplary embodiments are provided to effectively describe the spirit of the present disclosure to those skilled in the art.

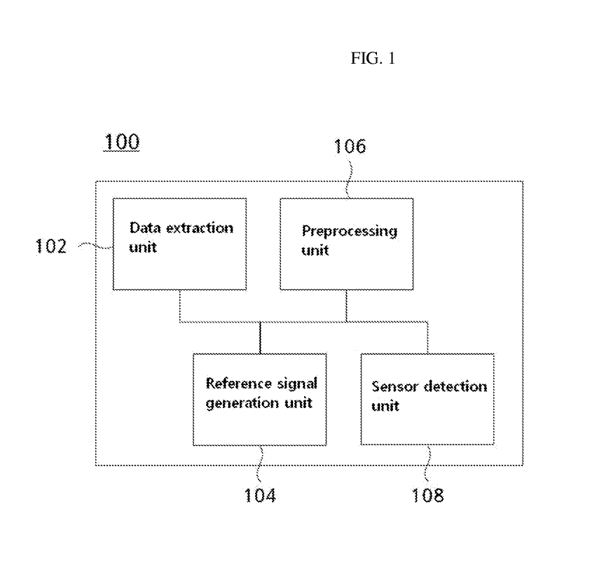

FIG. 1 is a block diagram for illustrating a sensed data analysis system 100 according to an exemplary embodiment of the present disclosure. In exemplary embodiments of the present disclosure, the sensed data analysis system 100 recognizes a factor having an effect on a state of a specific region or apparatus by analyzing sensed data output from one or more sensors arranged in the specific region or apparatus in conjunction with the state information of the region or apparatus.

In exemplary embodiments of the present disclosure, the sensed data analysis system 100 can recognize a factor suspected of being highly related to occurrence of an anomaly in a structure such as an elevator or a large power generator by analyzing sensed data output from various sensors, for example, a temperature sensor and a pressure sensor, installed in the structure, in conjunction with information regarding a state of the structure (e.g., a normal state or an anomalous state). For example, if there are a lot of instances in which an anomaly occurs in the structure with a value from a temperature sensor in a specific region equal to or greater than a predetermined value, a manager can determine that the region sensed by the temperature sensor in the structure is highly related to the anomaly of the structure based on the analysis results from the sensed data analysis system 100.

Furthermore, the sensed data analysis system 100 can detect the presence of a sensor highly related to a state of a specific building, a specific region in a building or an apparatus such as a vehicle or a ship from sensed data output from sensors arranged in the building, the region or the apparatus. In other words, it should be noted that embodiments of the present disclosure are not limited to what are sensed by the sensors.

The sensed data analysis system 100 according to an exemplary embodiment of the present disclosure includes a data extraction unit 102, a reference signal generation unit 104, a preprocessing unit 106, and a sensor detection unit 108, as shown in FIG. 1.

The data extraction unit 102 acquires sensed data from a plurality of sensors arranged in a specific region or apparatus. The reference signal generation unit 104 generates a reference signal for each of the plurality of sensors from the sensed data acquired by the data extraction unit 102. The preprocessing unit 106 performs a preprocessing operation to reduce the volume of the sensed data and that of the reference signal and remove the noise from the sensor data and that from the reference signal. The sensor detection unit 108 calculates a distance between the preprocessed sensed data and the preprocessed reference signal, and detects one or more sensors having a correlation with a state of the region or the apparatus using the distance.

Hereinafter, the respective components of the sensed data analysis system 100 configured as above will be described in more detail.

Data Extraction

The data extraction unit 102 extracts, from a specific region or apparatus, raw data to be analyzed. It processes the raw data into data having a format suitable for analysis. First, the data extraction unit 102 acquires sensed data from a plurality of sensors arranged in the specific region or apparatus.

In this case, the sensors are provided for detecting a change that occurs in the respective elements constituting the region or apparatus, and may be, for example, temperature sensors or pressure sensors arranged at some intervals in a specific region within a building. In other words, the temperature sensor or the pressure sensor may be configured to sense how the temperature or the pressure in the region changes over time. The data extraction unit 102 extracts, from such sensors, the sensed data sensed within the region or apparatus.

Further, the data extraction unit 102 may acquire information regarding a state of the region or apparatus, e.g., information regarding whether an anomaly occurs in the region or apparatus, and store such information in conjunction with the sensed data. In other words, since the data extraction unit 102 stores the sensed data, sensed by each sensor arranged in the specific region or apparatus, in conjunction with the state information of the region or apparatus, the data extraction unit 102 may trace how the state changes according to a change in the sensed data for a subsequent data analysis.

Meanwhile, due to various reasons, such as an error in data collection, a sensing error, or malfunction of the sensor, there may be values missing from the sensed data that was extracted by the data extraction unit 102. Accordingly, the data extraction unit 102 is configured to correct or filter the sensed data in consideration of the number of values missing from the sensed data.

For example, when the number of values missing from the sensed data extracted from a specific sensor exceeds a predetermined threshold value, the data extraction unit 102 may remove the sensed data extracted from that specific sensor so that a sensed value from the specific sensor can be excluded from a subsequent analysis. Further, the data extraction unit 102 may be configured to remove of the entire sensed data related to the specific region or apparatus when the number of values missing from the sensed data related to the specific region or apparatus exceeds a predetermined threshold value. For example, when the number of missing values of the sensed data collected in an interval in which the specific apparatus for the analysis is determined to be in an anomalous state is greater than a threshold value, the data extraction unit 102 may remove all the sensed data collected in the interval, and exclude the data in the period from a subsequent analysis. In other words, in an exemplary embodiment of the present disclosure, the data extraction unit 102 is configured to exclude all the sensor data from being analyzed when an excessive number of values are missing from the sensed data so that errors in the analysis results may be minimized.

On the other hand, when some values are missing from the sensed data but the number of the missing values does not exceed the predetermined threshold value, the data extraction unit 102 may correct the missing values using preceding and/or subsequent sensed data. For example, the data extraction unit 102 may correct a missing value using the following equation (1):

$$y = {y}_{a} + ( {y}_{b} - {y}_{a} ) \frac{x - {x}_{a}}{{x}_{b} - {x}_{a}} \qquad [ Equation 1 ]$$

where y denotes the missing value, x denotes the time corresponding to the missing value, yₐ denotes the sensed value immediately preceding the missing value, y_{b} denotes the sensed value immediately following the missing value, and xₐ and x_{b} respectively denote the time when the values of yₐ and y_{b} are sensed. However, the missing value correction equation of Equation (1) is only illustrative, and various other methods for supplying the missing value may be applied. In other words, it should be noted that embodiments of the present disclosure are not limited to a specific missing value correction algorithm.

Data Preprocessing and Reference Signal Generation

With the sensed data extracted as described above, the reference signal generation unit 104 then generates a reference signal for each of the plurality of sensors from the acquired sensed data, and the preprocessing unit 106 performs a preprocessing operation including at least one of compression, normalization or symbolization of the sensed data and the reference signal.

First, the preprocessing unit 106 compresses the sensed data with a plurality of time intervals. Specifically, the preprocessing unit 106 compresses the sensed data by grouping the sensed data into a plurality of time intervals (w time intervals) and calculating a representative value of the sensed data in each grouping time interval. In some case, the representative value may be set as an average value or a median value of the sensed data in each grouped time interval. When the sensed data is compressed as such, there is an advantage in that a total volume of the sensed data can be decrease and noise in the data can be reduced. In such a case, for example, a SAX (Symbolic ApproXimation) algorithm may be used to determine the value of w, i.e., the number of intervals to use for grouping the sensed data, but embodiments of the present disclosure are not necessarily limited thereto.

An exemplary process for such compression of the sensed data will be described below. First, it is assumed that the sensed data sensed at intervals of one second from a specific sensor are as follows:

3.5, 3.8, 3.9, 4.1, 4.5, 4.7, 4.8, 4.8, 4.8, 4.7, 4.8, 4.9, . . .

The sensed data is divided into four time intervals (w=4) and an average value is calculated for each interval, as shown in the following:

Period 1: (3.5+3.8+3.9)/3=3.7

Period 2: (4.1+4.5+4.7)/3=4.4

Period 3: (4.8+4.8+4.8)/3=4.8

Period 4: (4.7+4.8+4.9)/3=4.8

That is, in the above example, the sensed data may be compressed as follows.

3.7, 4.4, 4.8, 4.8

Then, the reference signal generation unit 104 generates the reference signal from the compressed sensed data. In an exemplary embodiment of the present disclosure, the reference signal refers to a signal used as a reference in calculating a distance of the sensed data for each sensor.

A process of generating the reference signal at the reference signal generation unit 104 will now be described. First, the reference signal generation unit 104 classifies the compressed sensed data for each sensor into a good group and a bad group based on state information of the region or the apparatus. In other words, the sensed data obtained when the region or the apparatus is in a normal state is included in the good group, and the sensed data obtained when the region or the device is in an anomalous state is included in the bad group.

Then, the reference signal generation unit 104 generates the reference signal by calculating either an average value or a median value of the sensed data belonging to the good group for each of the (w) time intervals. In other words, in an exemplary embodiment of the present disclosure, the reference signal may be defined as the average value or the median value of the sensed data belonging to the good group for each interval.

Meanwhile, the reference signal generation unit 104 may be configured to remove any outliers from the good group before generating the reference signal. An “outlier” is sensed data that erratically deviates from the other sensed data belonging to the good group. Since such outliers are generally generated in an usual situation, such as temporary failure of sensors or equipment, the reference signal would be rather distorted unless the outlier is excluded. Removing the outlier before generating the reference signal would then result in improved accuracy of the reference signal.

For example, with the data start time and the data end time for each sensed data, the reference signal generation unit 104 may be configured to calculate a distribution of the data start time or the data end time of the sensed data belonging to the good group, and to remove the sensed data for which the data start time and/or the data end time is not included in a predetermined normal range, when there is such sensed data. In this case, the normal range may be calculated using at least one of an average value or a standard deviation of the data start time or the data end time of the sensed data included in the good group.

For example, if the average value of the data start time of the sensed data included in the good group is m and the standard deviation thereof is s, the normal range of the data start time may be determined as shown in equation (2) below:

m−3s≦data start time≦m+3s [Equation 2]

In other words, the reference signal generation unit 104 may generate the reference signal using only sensed data that is not abnormal, i.e., other than data whose data start time is outside the above range, among the sensed data belonging to the good group. While only the normal range of the data start time is described in the above equation, that of the data end time can be calculated in a same way.

Then, the preprocessing unit 106 normalizes the compressed sensed data. Specifically, as shown in Equation 3, the preprocessing unit 106 may normalize the sensed data using an average and a variance of the reference signals:

$${y}_{i} = \frac{{x}_{i} - μ}{σ} \qquad [ Equation 3 ]$$

where xᵢ denotes an i-th sensed value of the sensed data, yᵢ denotes a normalized version of the i-th sensed value, μ denotes the average of the reference signal, and σ denotes the variance of the reference signal.

Then, the preprocessing unit 106 converts the normalized sensed value of the sensed data and the reference signal to a plurality of symbols according to a predetermined sensed value range (symbolization). Specifically, the preprocessing unit 106 may divide an entire interval in which the normalized sensed values are distributed into a plurality of sub-intervals (a sub-intervals), and provide each divided sub-interval with an individual symbol (e.g., an alphabet letter) to symbolized the sensor data. For example, the preprocessing unit 106 can divide the period in which the sensed values are distributed, using the following Equation 4:

$${y}_{i} = {Φ}^{- 1} ( \frac{i}{n} ) \qquad [ Equation 4 ]$$

where yᵢ denotes a threshold of an i-th sub-interval, n denotes the number of all sub-intervals, and Φ denotes a cumulative normal distribution.

For example, it is assumed that the normalized sensed data is as follows:

−0.3, −0.7, −0.2, 0.4, 0.8, . . .

When the sensed data is symbolized, as shown in Table 1 below, the above sensed data should be converted as follows:

TABLE 1

| Period | Symbol |
|---|---|
| greater than or equal to −1.0 and less than −0.5 | A |
| greater than or equal to −0.5 and less than 0 | B |
| greater than or equal to 0 and less than 0.5 | C |
| greater than or equal to 0.5 and less than 1.0 | D |

Symbolized sensed data: BABCD

Distance Table Generation and Sensor Detection

Once the preprocessing of the sensed data in the preprocessing unit 106 is complete, the sensor detection unit 108 calculates a distance between the preprocessed sensed data and the preprocessed reference signal, and detects one or more sensors having a correlation with a state of the region or the apparatus using the calculated distance.

First, the sensor detection unit 108 calculates a distance (MDIST) between each sensed value of the preprocessed sensed data and the preprocessed reference signal. The distance may be calculated, for example, using the following Equation 5:

$${MDIST}_{i} = \{ \begin{matrix}0 , & if {Q}_{i} = {P}_{i} \\ {y}_{max ( r , e ) - 1} - {y}_{min ( r , e )} , & otherwise\end{matrix} \qquad [ Equation 5 ]$$

Equation 5 is used for calculating the distance (MDISTᵢ) between i-th elements (Qi, Pi) of two time series datasets Q and P, each of which is represented by n symbols. In Equation 5, r and c denote a position of a row (r) and that of a column (c) of a lookup table consisting of Qᵢ and Pᵢ, respectively.

When the distance between each sensed value and the reference signal is calculated as described above, or in some other manner, the sensor detection unit 108 generates a distance table using the distance value and the state information of the region or the apparatus. In an exemplary embodiment of the present disclosure, the sensor detection unit 108 may generate two distance tables including a first distance table and a second distance table. In the first one of these distance tables, the distance between each sensed value and the reference signal in the respective time interval is recorded. For example, it is assumed below that, in time intervals I1, I2 and I3, the sensed values from a pressure sensor and a temperature sensor arranged in a specific apparatus, and the reference signal are given as shown in Table 2 below.

TABLE 2

| | Sensor | | | | | | |
|---|---|---|---|---|---|---|---|
| | Pressure | | | Temperature | | | |
| Interval | I1 | I2 | I3 | I1 | I2 | I3 | State information |
| Reference signal | C | C | C | C | D | A | |
| Sensed data 1 | C | C | B | C | D | B | Normal |
| Sensed data 2 | A | C | D | A | C | E | Anomalous |

In this case, the first distance table may be calculated as shown in Table 3 below.

TABLE 3

| | Sensor | | | | | | |
|---|---|---|---|---|---|---|---|
| | Pressure | | | Temperature | | | |
| Period | I1 | I2 | I3 | I1 | I2 | I3 | State information |
| Sensed data 1 | 0 | 0 | 1 | 0 | 0 | 1 | Normal |
| Sensed data 2 | 2 | 0 | 1 | 2 | 1 | 4 | Anomalous |

In the second distance table, a sum of the distances (MDIST) in the first distance table is recorded for each sensor. For example, the second distance table is generated from the distance table of Table 3, as shown in Table 4 below:

TABLE 4

| Sensor | Pressure | Temperature | State information |
|---|---|---|---|
| Sensed data 1 | 1 | 1 | Normal |
| Sensed data 2 | 3 | 7 | Anomalous |

If the distance tables are generated as described above, the sensor detection unit 108 then generates a decision tree by applying a CART (Classification And Regression Tree) algorithm to the distance tables. Specifically, the sensor detection unit 108 may apply the CART algorithm to the first distance table and the second distance table to generate two decision trees, respectively. In this case, the first distance table may be used to recognize which interval of the sensed data has an effect on the state of the region or the apparatus, while the second distance table may be used to recognize which sensor generally has an effect on the state of the region or the apparatus.

With the CART algorithm applied to the distance tables as described above, a Gini index is calculated for each sensor corresponding to a node of a decision tree. The Gini index indicates an effect of the sensor, corresponding to the node, on the state of the region or the apparatus, meaning that the higher the Gini index, the greater the effect of the sensor on the state of the region or the apparatus. Therefore, the sensor detection unit 108 may sort the sensors according to the Gini indexes derived from the application of the CART algorithm, and may thus detect a sensor whose Gini index is equal to or more than a predetermined value as a sensor having a high correlation with state of the region or the apparatus.

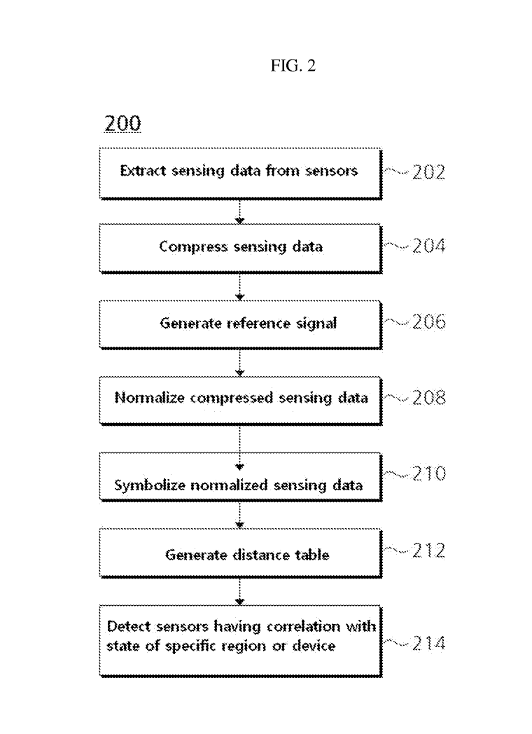

FIG. 2 is a flowchart for illustrating a sensed data analysis method 200 according to an exemplary embodiment of the present disclosure. First, the data extraction unit 102 extracts the sensed data from a plurality of sensors arranged in a specific region or apparatus (202). As described above, the extracting of the sensor data (202) may include correcting or filtering the sensed data based on the number of values missing from the sensed data. For example, when the number of values missing from the sensed data extracted from a specific sensor exceeds a predetermined threshold value, the data extraction unit 102 may remove the sensed data extracted from that specific sensor. Further, when the number of values missing from the sensed data related to a specific state exceeds a predetermined threshold value, the data extraction unit 102 may remove all the sensed data related to that specific state.

Then, the preprocessing unit 106 compresses the extracted sensed data (204). Specifically, the compressing of the extracted sensed data (204) may include grouping the sensed data into a plurality of time intervals, and calculating a representative value of the sensed data in each grouping time interval. In this case, the representative value may be either an average value or a median value of the sensed data in each grouping time interval.

Then, the reference signal generation unit 104 generates a reference signal for each of the plurality of sensors from the sensed data (206). In this case, the generating of the reference signal (206) may include grouping the compressed sensed data for each sensor into a good group and a bad group based on the state information of the region or the apparatus, and calculating either an average value or a median value of the sensed data belonging to the good group for each time interval.

Further, the reference signal generation unit 104 may be configured to remove an outlier from the good group before generating the reference signal, as described above. In this case, the outlier refers to sensed data of which at least one of data start time and data end time is not included in a predetermined normal range, as already described above. The normal range may be calculated using either an average value or a standard deviation of the data start time or the data end time of the sensed data included in the good group.

With the reference signal generated as described above, the preprocessing unit 106 normalizes the compressed sensed data using an average and a variance of the reference signal (208), and converts a sensed value of the normalized sensed data, and the reference signal, to a plurality of symbols according to a predetermined sensed value range (210).

Then, the sensor detection unit 108 calculates a distance between the sensed data and the reference signal, generates a distance table using the calculated distance (212), and detects one or more sensors having a correlation with a state of the region or the apparatus using the distance table (214). As described above, the sensor detection unit 108 may be configured to apply a CART (Classification And Regression Tree) algorithm to the distance table, and detect a sensor for which a Gini index derived from the application of the CART algorithm is equal to or more than a predetermined value as a sensor having a correlation with a state of the region or apparatus.

Meanwhile, exemplary embodiments of the present disclosure may include a computer-readable recording medium including a program for performing the methods described in the present specification in a computer. The computer-readable recording medium may include program instructions, local data files, and local data structures, alone or in combination. The medium may be specially designed and configured for the present disclosure, or well known and available to those skilled in the field of computer software. Examples of the computer-readable recording medium include magnetic media such as a hard disk, a floppy disk and a magnetic tape, optical recording media such as a CD-ROM and a DVD, a magneto-optical medium such as a floptical disk, and hardware devices, specially configured to store and execute program instructions, such as a ROM, a RAM, and a flash memory. Examples of the program instructions may include high-level language codes executable by a computer using an interpreter or the like, as well as machine language codes made by a compiler. Furthermore, an exemplary embodiment may include a device with a processor and a memory for using such a program and/or computer-readable medium.

According to embodiments of the present disclosure, it is advantageous to analyze data output from sensors arranged in a specific region or apparatus, thereby precisely recognizing a sensor related to a state of the specific region or apparatus.

Further, it is also advantageous to perform preprocessing on the sensed data having a huge volume and summarize the sensed data, thereby reducing the volume of the data and effectively removing noise introduced in sensing the data. Accordingly, a technique is available for effectively analyzing the sensed data while exploiting time series characteristics of the data as well.

While the present disclosure has been described above in detail through the representative exemplary embodiments, it will be apparent to those skilled in the art that various modifications can be made to the above-described exemplary embodiments of the present disclosure without departing from the spirit or scope of the present disclosure.

Thus, it is intended that the present disclosure cover all such modifications that fall within the scope of the appended claims and their equivalents.

What is claimed is:

1. A system intended for use in analyzing sensed data, the system comprising a computer executing program commands and implementing:
a data extraction unit configured to extract respective sensed data from each sensor of a plurality of sensors arranged in a specific region or apparatus;
a reference signal generation unit configured to generate a reference signal for said each sensor, from the sensed data; and
a sensor detection unit configured to detect one or more sensors of the plurality of sensors having a correlation with a state of the specific region or apparatus using the sensed data and the reference signal.

2. The system according to claim 1, wherein the data extraction unit is further configured to carry out one of a correction operation and a filter operation with respect to the sensed data, based on a number of values missing from the sensed data.

3. The system according to claim 2, wherein the data extraction unit is further configured to remove the sensed data, extracted from a specific sensor of the plurality of sensors, when the number of values missing from the respective extracted sensed data exceeds a predetermined threshold value.

4. The system according to claim 2, wherein the data extraction unit is further configured to remove the sensed data related to a specific state when the number of values missing from the sensed data related to the specific state exceeds a predetermined threshold value.

5. The system according to claim 1, wherein the sensor detection unit is further configured to calculate a distance between the respective sensed data and the reference signal, and detects one or more of the plurality of sensors having a correlation with the state of the specific region or apparatus based on the calculated distance.

6. The system according to claim 1, further comprising a preprocessing unit configured to perform preprocessing with respect to the sensed data and the reference signal, including at least one of a compression operation, a normalization operation, and a symbolization operation.

7. The system according to claim 6, wherein the preprocessing unit is further configured to compress the sensed data by:
grouping the sensed data into a plurality of time intervals; and
calculating a representative value of the sensed data in each of the grouping time intervals.

8. The system according to claim 7, wherein the representative value is one of an average value and a median value of the sensed data, in each grouped time interval.

9. The system according to claim 7, wherein the reference signal generation unit is further configured to:
generate the reference signal by grouping the compressed sensed data from each sensor into one of a good group and a bad group, based on state information of one of the specific region and apparatus; and
calculate one of an average value and a median value of the sensed data belonging to the good group, for each time interval.

10. The system according to claim 9, wherein the reference signal generation unit is further configured to remove an outlier from the good group before generating the reference signal.

11. The system according to claim 10, wherein at least one of a data start time and a data end time of the outlier is not included in a predetermined normal range.

12. The system according to claim 11, wherein the normal range is calculated using at least one of an average value and a standard deviation of one of the data start time and the data end time of the sensed data included in the good group.

13. The system according to claim 6, wherein the preprocessing unit is further configured to:
normalize the compressed sensed data using an average and a variance of the reference signal; and
convert a sensed value of the normalized sensed data and the reference signal to a plurality of symbols according to a predetermined sensed value range.

14. The system according to claim 13, wherein the sensor detection unit is further configured to generate a decision tree by:
generating a distance table using the symbolized sensed data and reference signal, and the state information of the specific region or apparatus; and
applying a CART (Classification And Regression Tree) algorithm to the distance table.

15. The system according to claim 14, wherein the sensor detection unit is further configured to detect, as a sensor having a correlation with the state of the specific region or apparatus, a sensor for which a Gini index, derived from the application of the CART algorithm, is at least a predetermined value.

16. A method, intended for use in analyzing sensed data, the method comprising:
extracting, by a data extraction unit, sensed data from each sensor of a plurality of sensors included in a specific region or apparatus;
generating, by a reference signal generation unit, a reference signal for said each sensor, from the sensed data; and
detecting, by a sensor detection unit, one or more sensors of the plurality of sensors having a correlation with a state of the specific region or apparatus, using the sensed data and the reference signal.

17. The method according to claim 16, wherein the extracting of the sensed data includes carrying out one of a correcting operation and a filtering operation with respect to the sensed data, based on a number of values missing from the sensed data.

18. The method according to claim 17, further comprising removing the sensed data extracted, from a specific sensor of the plurality of sensors, when the number of values missing from the respective extracted sensed data exceeds a predetermined threshold value.

19. The method according to claim 17, further comprising removing the sensed data related to a specific state when the number of values missing from the sensed data related to the specific state exceeds a predetermined threshold value.

20. The method according to claim 16, wherein the detecting of the sensors includes calculating a distance between the respective sensed data and the reference signal, and detecting one or more of the plurality of sensors having a correlation with the state of the specific region or apparatus based on the calculated distance.

21. The method according to claim 16, further comprising, after the extracting of the sensed data and before the generating of the reference signal, compressing the extracted sensed data using a preprocessing unit.

22. The method according to claim 21, wherein the compressing of the sensed data includes:
grouping the sensed data into a plurality of time intervals; and
calculating a representative value of the sensed data in each grouping time interval.

23. The method according to claim 22, wherein the representative value is one of an average value and a median value of the sensed data in each grouped time interval.

24. The method according to claim 22, wherein the generating of the reference signal for each sensor includes:
grouping the compressed sensed data from each sensor into one of a good group and a bad group based on state information of the specific region or apparatus; and
calculating one of an average value and a median value of the sensed data belonging to the good group, for each time interval.

25. The method according to claim 24, wherein the grouping of the compressed sensed data includes removing an outlier from the good group.

26. The method according to claim 25, wherein at least one of a data start time and a data end time of the outlier is not included in a predetermined normal range.

27. The method according to claim 26, wherein the normal range is calculated using at least one of an average value and a standard deviation of one of the data start time and the data end time of the sensed data included in the good group.

28. The method according to claim 21, further comprising, before the detecting of the one or more sensors:
normalizing, by the preprocessing unit, the compressed sensed data using an average and a variance of the reference signal; and
converting, by the preprocessing unit, a sensed value of the normalized sensed data and the reference signal to a plurality of symbols according to a predetermined sensed value range.

29. The method according to claim 28, wherein the detecting of the one or more sensors includes:
generating a distance table using the symbolized sensed data and reference signal and the state information of the specific region or apparatus; and
applying a CART (Classification And Regression Tree) algorithm to the distance table.

30. The method according to claim 29, wherein the detecting of the one or more sensors further includes detecting, as a sensor having a correlation with the state of the specific region or apparatus, a sensor for which a Gini index derived from the application of the CART algorithm is at least a predetermined value.

31. A device comprising:
one or more processors;
a memory; and
one or more programs stored in the memory, the one or more programs being configured to be executed by the one or more processors;
wherein the one or more programs enable the one or more processors to carry out operations, comprising:
extracting sensed data from each sensor of a plurality of sensors arranged in a specific region or apparatus;
generating a reference signal for said each sensor from the sensed data; and
detecting one or more sensors of the plurality of sensors having a correlation with a state of the specific region or apparatus, using the sensed data and the reference signal.
